(19) United States
(12) Patent Application Publication
(10) Pub. No.: US 2016/0300201 A1
(43) Pub. Date: Oct. 13, 2016

(54) METHOD, DEVICE AND SYSTEM FOR PERFORMING TRANSACTIONS

(71) Applicant: Tencent Technology (Shenzhen) Company Limited, Shenzhen (CN)

(72) Inventors: Shanlin LI, Shenzhen (CN); Wenxing WANG, Shenzhen (CN); Jing GAO, Shenzhen (CN); Kan ZHANG, Shenzhen (CN)

(21) Appl. No.: 15/184,785

(22) Filed: Jun. 16, 2016

Related U.S. Application Data
(63) Continuation of application No. PCT/CN2014/095167, filed on Dec. 26, 2014.

(30) Foreign Application Priority Data
Dec. 31, 2013 (CN) 201310754734.4

(51) Int. Cl. G06Q 20/10; G06Q 20/06

(52) U.S. Cl. CPC G06Q 20/10; G06Q 20/065

(57) ABSTRACT

A method for performing transactions is disclosed. The method is performed at a server device having one or more processors and memory for storing programs to be executed by the one or more processors. The method includes receiving, from a terminal device, a virtual resource transfer instruction associated with transferring virtual resource into a virtual account of a user. Virtual resource recorded in the virtual account corresponds to actual resource of the user used in a revenue-generation activity. The method also includes sending a resource transfer request to cause completion of an actual resource transfer in accordance with the virtual resource transfer instruction. The method further includes increasing an account balance of the virtual account in accordance with the virtual resource transfer instruction. The user can use the value of virtual resource transferred into the virtual account to perform commercial transactions from the terminal device.

### PRIORITY CLAIM AND RELATED APPLICATION

This application is a continuation application of PCT Patent Application No. PCT/CN2014/095167, entitled “METHOD, DEVICE AND SYSTEM FOR PERFORMING TRANSACTIONS” filed on Dec. 26, 2014, which claims priority to Chinese Patent Application Serial No. 201310754734.4, entitled “DATA PROCESSING METHOD, VALUE-ADDING SERVER AND SYSTEM,” filed on Dec. 31, 2013, both of which are incorporated herein by reference in their entirety.

### FIELD OF THE APPLICATION

The present application generally relates to the field of Internet technologies, and more particularly to a method, device and system for performing transactions associated with transferring funds.

### BACKGROUND

Some known account management systems are used to manage funds for users. In such known account management systems, however, funds used in revenue-generation activities and funds available to the user for real-time consumption are typically associated with separate accounts of a user. In other words, funds associated with any given account are typically either used in revenue-generation or available for real-time consumption, but not both at the same time. As a result, users are required to transfer funds between accounts whenever they want to change the use of the funds. Such a required fund-transfer process can be complicated and vulnerable to security risks.

Therefore, a need exists for a method, device and system that can make funds in a user account available for both revenue-generation activities and real-time consumption.

### SUMMARY

The above deficiencies associated with the known account management systems may be addressed by the techniques described herein.

In some embodiments, a method for performing transactions and/or transferring funds is disclosed. The method is performed at a server device having one or more processors and memory for storing programs to be executed by the one or more processors. The method includes receiving, from a terminal device of a user, a virtual resource transfer instruction associated with transferring funds into a virtual account of the user. Such a virtual resource transfer instruction includes a value of virtual resource to be transferred into the virtual account of the user. At least a portion of virtual resource recorded in the virtual account of the user corresponds to actual resource in a different account of the user used in a revenue-generation activity.

The method includes sending, in response to the virtual resource transfer instruction, a resource transfer request to cause an actual resource transfer server to complete an actual resource transfer in accordance with the virtual resource transfer instruction. The resource transfer request includes the value of virtual resource to be transferred into the virtual account of the user. Specifically, in some instances, the server device sends the resource transfer request to an account management server. The server device then receives, from the account management server, a resource transfer order in response to the resource transfer request. The server device further sends, in response to the resource transfer order, an instruction to the actual resource transfer server to cause the actual resource transfer server to complete the actual resource transfer in accordance with the virtual resource transfer instruction.

The method includes receiving, from the actual resource transfer server, a message indicating the completion of the actual resource transfer. The method also includes increasing, in response to the message from the actual resource transfer server, an account balance of the virtual account of the user by the value of virtual resource to be transferred. The method further includes sending, to the terminal device, a message indicating the completion of the virtual resource transfer. As a result, the user of the terminal device can use the value of virtual resource transferred into the virtual account of the user to perform commercial transactions from the terminal device.

In some instances, the method includes receiving, from the terminal device of the user, another virtual resource transfer instruction associated with transferring funds out of the virtual account of the user. Such a virtual resource transfer instruction includes a value of virtual resource to be transferred out of the virtual account of the user. The method includes deducting, from the account balance of the virtual account of the user and in response to the virtual resource transfer instruction, the value of virtual resource to be transferred out of the virtual account of the user. The method includes transferring actual resource out of a resource transfer account of the user in accordance with the virtual resource transfer instruction. The method also includes sending, to the terminal device of the user, a message indicating the completion of the virtual resource transfer in accordance with the virtual resource transfer instruction.

The method further includes sending, in response to the completion of the virtual resource transfer, a resource transfer request such that actual resource is transferred from the account of the user into the resource transfer account of the user. The account of the user is associated with actual resource of the user used in the revenue-generation activity. Specifically, the server device sends the resource transfer request to the account management server such that the account management server transfers the actual resource from the account of the user into the resource transfer account of the user in accordance with the virtual resource transfer instruction.

In some embodiments, a server device includes one or more processors and memory storing one or more programs for execution by the one or more processors. The one or more programs include instructions that cause the server device to perform the method for performing transactions and/or transferring funds as described above. In some embodiments, a non-transitory computer readable storage medium stores one or more programs including instructions for execution by one or more processors. The instructions, when executed by the one or more processors, cause the processors to perform the method for performing transactions and/or transferring funds at a server device as described above.

Various advantages of the present application are apparent in light of the descriptions below.

### BRIEF DESCRIPTION OF DRAWINGS

The aforementioned implementation of the application, as well as additional implementations will be more clearly understood as a result of the following detailed description of the various aspects of the application when taken in conjunction with the drawings.

FIG. 1 is a flow chart illustrating a method performed at a server device for transferring fund into a virtual account in accordance with some embodiments.

FIGS. 2-4 are schematic diagrams illustrating user interfaces of a terminal device associated with the method in FIG. 1.

FIG. 5 is a flow chart illustrating a method performed at a system for transferring fund into a virtual account in accordance with some embodiments.

FIG. 6 is a flow chart illustrating another method performed at a server device for transferring fund out of a virtual account in accordance with some embodiments.

FIGS. 7-8 are schematic diagrams illustrating user interfaces of a terminal device associated with the method in FIG. 6.

FIG. 9 is a flow chart illustrating a method performed at a system for transferring fund out of a virtual account in accordance with some embodiments.

FIG. 10 is a flow chart illustrating a method performed at a server device for transferring fund into a virtual account in accordance with some embodiments.

FIG. 11 is a flow chart illustrating a method performed at a server device for transferring fund out of a virtual account in accordance with some embodiments.

FIG. 12 is a block diagram illustrating modules of a server device configured to transfer funds in accordance with some embodiments.

FIG. 13 is a block diagram illustrating modules of another server device configured to transfer funds in accordance with some embodiments.

FIG. 14 is a schematic diagram illustrating components of a server device configured to transfer funds in accordance with some embodiments.

FIG. 15 is a schematic diagram illustrating a system configured to transfer funds in accordance with some embodiments.

Like reference numerals refer to corresponding parts throughout the several views of the drawings.

### DETAILED DESCRIPTION

Reference will now be made in detail to embodiments, examples of which are illustrated in the accompanying drawings. In the following detailed description, numerous specific details are set forth in order to provide a thorough understanding of the subject matter presented herein. But it will be apparent to one skilled in the art that the subject matter may be practiced without these specific details. In other instances, well-known methods, procedures, components, and circuits have not been described in detail so as no unnecessarily obscure aspects of the embodiments.

In order to make the objectives, technical solutions, and advantages of the present application comprehensible, embodiments of the present application are further described in detail below with reference to the accompanying drawings.

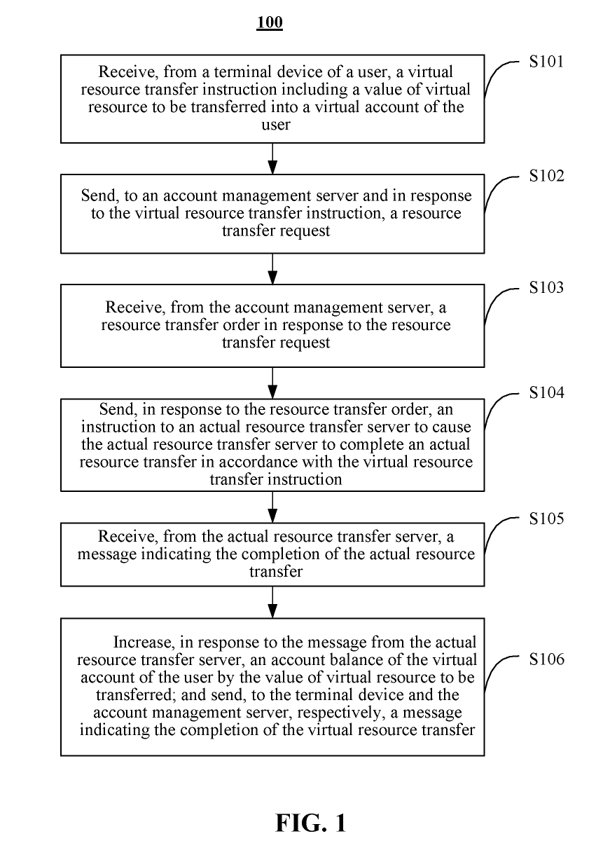

FIG. 1 is a flow chart illustrating a method 100 performed at a server device for performing a transaction in accordance with some embodiments. Such a server device is configured to be operatively coupled to and communicate with one or more terminal devices and other servers such as, for example, an account management server, an actual resource transfer server, etc. The one or more terminal devices can be operated by one or more users. In some embodiments, a user can operate more than one terminal device (e.g., a desktop computer, a laptop, a smart phone) to interact with the server device. In some embodiments, more than one user (e.g., members of a family) can operate a single terminal device to interact with the server device.

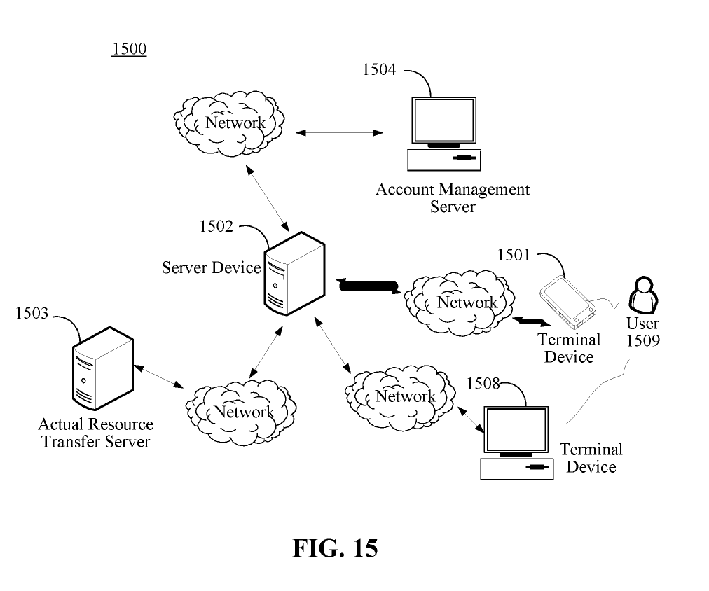

As an example, FIG. 15 is a schematic diagram illustrating a system 1500 configured to transfer funds in accordance with some embodiments. As shown in FIG. 15, the system 1500 includes at least a server device 1502, an account management server 1504 and an actual resource transfer server 1503. The server device 1502 can be configured to perform the method 100. In some embodiments, the server device 1502 can be directly connected to the account management server 1504 and/or the actual resource transfer server 1503 (not shown in FIG. 15). In other embodiments, the server device 1502 can be operatively coupled to the account management server 1504 and/or the actual resource transfer server 1503 via one or more networks, as shown in FIG. 15. Furthermore, the server device 1502 is operatively coupled to (e.g., via one or more networks as shown in FIG. 15) one or more terminal devices such as terminal devices 1501, 1508 operated by a user 1509 as shown in FIG. 15.

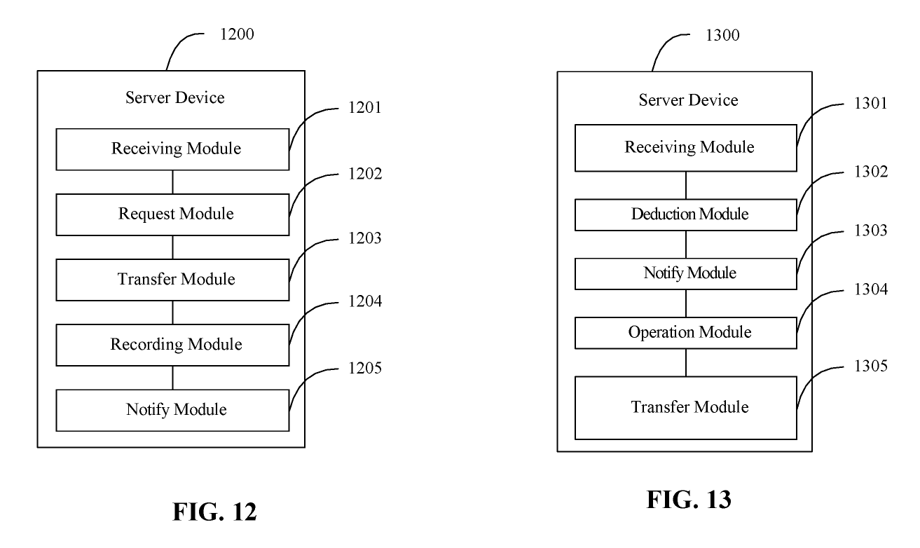

A server device described herein (e.g., the server device 1502 in FIG. 15) can he any type of device that is configured to function as a server-side device to manage accounts, transfer funds between accounts, process account-related data, and provide other related services for users of the accounts. Such a server device can typically be configured to communicate with multiple terminal devices and/or other devices (e.g., account management server, actual resource transfer server, etc.) Via one or more networks. In some embodiments, a server device can be, for example, a background server, a back end server, a database server, a workstation, a desktop computer, a cloud computing server, a data processing server, and/or the like. In some embodiments, a server device can be a server cluster or server center consisting of two or more servers (e.g., a data processing server and a database server). In some embodiments, such a server device can be referred to as, for example, a value-added server. Details of a server device are shown and described below with respect to FIGS. 12-14.

An account management server described herein (e.g., the account management server 1504 in FIG. 15) can be any type of device that is configured to provide a platform for managing accounts of users. Specifically, an account management server can be configured to manage account activities such as, for example, opening a new account, transferring funds between accounts, purchasing funds of an account, redeeming funds of an account, and/or the like. An actual resource transfer server described herein (e.g., the actual resource transfer server 1503 in FIG. 15) can be any type of device that is configured to enable transfer of actual resource (e.g., money, stocks, bonds, securities, properties, and/or any other type of valuable assets) between accounts. Such an actual resource transfer server can be associated with an online payment platform and/or a bank. Similar to a server device described above, an account management server or an actual resource transfer server can be, for example, a background server, a back end server, a database server, a workstation, a desktop computer, a cloud computing server, a data processing server, a server cluster, a server center, and/or the like.

A terminal device described herein (e.g., the terminal device 1501 or 1508 in FIG. 15) can be any type of electronic device configured to function as a client-side device to manage accounts, transfer funds between accounts, and provide other related services to a user operating that terminal device. In some embodiments, such a terminal device can be, for example, a cellular phone, a smart phone, a mobile Internet device (MID), a personal digital assistant (PDA), a palmtop computer, a tablet computer, an e-reader, a laptop computer, a handheld computer, a wearable device, a desktop computer, a vehicle terminal, and/or the like. In some embodiments, such a terminal device can be referred to as, for example, a client device, a user device, a mobile device, a portable device, a terminal, and/or the like. In some embodiments, one or more software applications related to the account management service and/or other related services are installed and executed at a terminal device.

A network connecting a server device with a terminal device or any other device (e.g., an account management server, an actual resource transfer server) can be any type of network configured to operatively couple one or more server devices to one or more terminal devices and/or other devices, and enable communications between the server device(s) and the connected device(s). In some embodiments, such a network can include one or more networks such as, for example, a cellular network, a satellite network, a local area network (LAN), a wide area network (WAN), a wireless local area network (WLAN), Internet, etc. In some embodiments, such a network can be optionally implemented using any known network protocol including various wired and/or wireless protocols such as, for example, Ethernet, universal serial bus (USB), global system for mobile communications (GSM), enhanced data GSM environment (EDGE), general packet radio service (GPRS), long term evolution (LTE), code division multiple access (CDMA), wideband code division multiple Access (WCDMA), time division multiple access (TDMA), Bluetooth, Wi-Fi, voice over internet protocol (VoIP), Wi-MAX, etc.

A user operating a terminal device can be any person interested in using the account management service and other related services provided by the terminal device, the server device and/or other devices included in a system (e.g., the system 1500). Such a user typically is an owner of one or more accounts and a party of an online transaction. In some embodiments, a user can be an owner of multiple accounts. In some embodiments, a user can be a party of multiple online transactions. In some embodiments, a user operating a terminal device can use the account management service and other related services to, for example, manage her accounts, make online payments, transfer money, etc.

Returning to FIG. 1, in some embodiments, the server device performing the method 100 can include one or more processors and memory. In such embodiments, the method 100 is governed by instructions or code of an application that are stored in a non transitory computer readable storage medium of the server device and executed by the one or more processors of the server device. The application is associated with transferring funds into a virtual account of a user, who operates a terminal device to interact with the server device. Such an application typically has a server-side portion that is stored in and/or executed at the server device, and a client-side portion that is stored in and/or executed at the terminal device(s) operatively coupled to the server device. As a result of the server-side portion of the application being executed, the method 100 is performed at the server device. As shown in FIG. 1, the method 100 includes the following steps.

At S101, the server device receives, from the terminal device of the user, a virtual resource transfer instruction including a value of virtual resource to be transferred into the virtual account of the user. At least a portion of virtual resource recorded in the virtual account of the user corresponds to actual resource in a different account of the user used in a revenue-generation activity. The revenue-generation activity can be any activity that potentially increases the value of the actual resource in the account of the user. Such a revenue-generation activity can be, for example, an investing activity or a combination of multiple investing activities. For example, the actual resource in the account can be used to purchase a fund product, invest in stock market, and/or the like.

As described above, actual resource can include any type of valuable assets such as, for example, money, stocks, bonds, securities, properties, and/or the like. In some embodiments, actual resource associated with the account of the user includes a combination of different valuable assets. The virtual account of the user is typically synchronized with the account of the user such that the virtual resource recorded in the virtual account accurately represents the actual resource in the account of the user. As such, the value of the virtual resource recorded in the virtual account corresponds to the value of the actual resource in the account of the user.

In some embodiments, the user operates the terminal device to transfer virtual resource into the virtual account of the user. The virtual resource transferred corresponds to actual resource that is to be transferred into the account of the user. Such actual resource can be transferred from, for example, a bank account or another account (e,g., stock exchange account) of the user. Corresponding to the actual resource transfer, virtual resource is transferred into the virtual account of the user. Thus, the terminal device generates and sends the virtual resource transfer instruction to the server device. Furthermore, the value of virtual resource to be transferred into the virtual account is based on the value of actual resource to be transferred into the account of the user. In some embodiments, the value of virtual resource to be transferred is equal to the value of actual resource to be transferred. In some other embodiments, the value of virtual resource to be transferred is less than the value of actual resource to be transferred. In such embodiments, the value of actual resource to be transferred can be the value of virtual resource to be transferred plus, for example, a processing fee for performing this transaction. Furthermore, in some embodiments, such a processing fee can be based on (e.g., a percentage of) the value of virtual resource to be transferred.

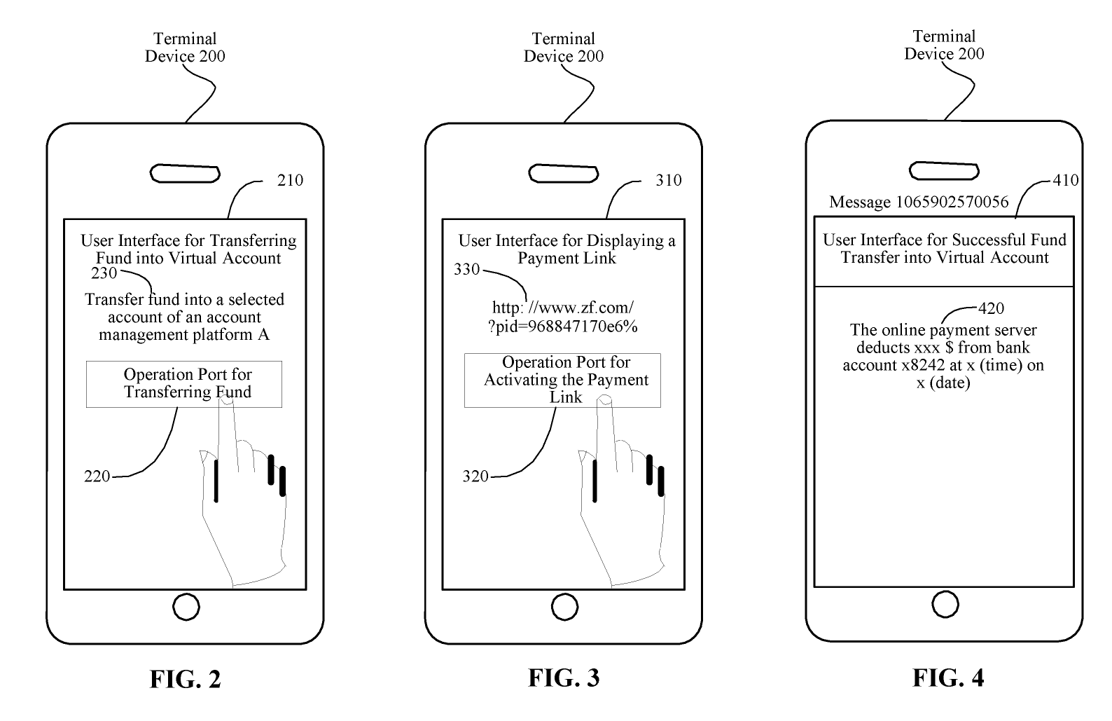

FIG. 2 is a schematic diagram illustrating a user interface 210 of a terminal device 200 associated with the method 100 in FIG. 1. The terminal device 200 can be operated by a user and can be similar to the terminal device described above with respect to performing the method 100 in FIG. 1. As shown in FIG. 2, the user interface 210 of the terminal device 200 displays a message 230 that prompts the user to activate the operation port for transferring fund by clicking the button 220. As a result of the user clicking the button 220, the terminal device 200 sends a virtual resource transfer instruction to a server device communicating with the terminal device 200.

In some embodiments, after the user clicks the button 220 to activate the operation port for transferring fund, the terminal device 200 displays another user interface (not shown in FIG. 2) for the user to enter data and/or information of the intended transaction. Specifically, the user can be prompted to, for example, select a virtual account (corresponding to an actual-resource account associated with actual resource used in revenue-generation activities) into which the virtual resource is transferred, select an account (e.g., a bank account) from which the actual resource is transferred, enter a value of virtual resource to be transferred, and/or the like. The terminal device 200 then generates a virtual resource transfer instruction based on the entered data and/or information, and then sends the virtual resource transfer instruction to the server device communicating with the terminal device 200.

Returning to FIG. 1, in response to the virtual resource transfer instruction, the server device then sends a resource transfer request to cause an actual resource transfer server to complete the actual resource transfer in accordance with the virtual resource transfer instruction. The actual resource transfer server can be similar to the actual resource transfer server 1503 show and described above with respect to FIG. 15. The actual resource transfer can be performed in various methods. As an example, S102-S104 in the method 100 illustrates one method to perform the actual resource transfer.

At S102, the server device sends, to an account management server and in response to the virtual resource transfer instruction, a resource transfer request. The account management server can be similar to the account management server 1504 show and described above with respect to FIG. 15. The resource transfer request includes the value of virtual resource to be transferred into the virtual account of the user. The server device generates the resource transfer request based on data and/or information included in the virtual resource transfer instruction. In some embodiments, the resource transfer request includes other data and/or information associated with the intended transfer such as, for example, a name of the user, an account number of the user, a value of resource (e.g., virtual resource, actual resource) recorded in an account (e.g., a virtual account, an actual-resource account) of the user, and/or the like.

In some embodiments, the virtual resource transfer instruction includes an instruction for transferring virtual resource (corresponding to actual resource) into multiple virtual accounts of the user. For example, the user intends to purchase multiple fund products, each of which is uniquely linked to a virtual account from a set of virtual accounts of the user. Thus, the virtual resource transfer instruction includes an instruction for transferring virtual resource (corresponding to money that is used to purchase the fund products) into each virtual account from the set of virtual accounts of the user.

At S103, the server device receives, from the account management server, a resource transfer order in response to the resource transfer request. The account management server generates the resource transfer order based on data and/or information included in the resource transfer request. The resource transfer order includes data and/or information of the actual resource transfer corresponding to the virtual resource transfer in accordance with the virtual resource transfer instruction. The resource transfer order includes, for example, a name or identification (e.g., unique number) of the user's account (e.g., the virtual account, the actual-resource account), the value of virtual resource to be transferred, time of the transfer request, and/or the like.

In some embodiments, multiple virtual accounts of the user can be managed and supported by more than one account management servers. For example, virtual accounts associated with fund products are managed by an account management server, and virtual accounts associated with stock products are managed by another account management server. In such embodiments, if the virtual resource transfer instruction includes an instruction for transferring virtual resource into multiple virtual accounts of the user, then the server device can send multiple resource transfer requests to more than one account management server accordingly. Specifically, each resource transfer request sent to an account management server includes information associated with transferring virtual resource to virtual account(s) managed by that account management server. In response, the server device can receive multiple resource transfer orders from the multiple account management servers.

At S104, the server device sends, in response to the resource transfer order, an instruction to the actual resource transfer server to cause the actual resource transfer server to complete an actual resource transfer in accordance with the virtual resource transfer instruction. In some embodiments, to initiate the actual resource transfer, the server device sends, to the terminal device of the user, a link (e.g., a payment link) associated with the actual resource transfer. In response to receiving the link, the terminal device of the user sends an instruction to the actual resource transfer server to cause the actual resource transfer server to complete the actual resource transfer in accordance with the virtual resource transfer instruction.

FIG. 3 is a schematic diagram illustrating a user interface 310 of the terminal device 200 associated with the method 100 in FIG. 1. As shown in FIG. 3, the user interface 310 of the terminal device 200 displays a payment link 330, which is received from the server device communicating with the terminal device 200. The payment link 330 is associated with the actual resource transfer corresponding to the virtual resource transfer. The user of the terminal device 200 is prompted to activate the payment link 230 by clicking the button 320. As a result, the terminal device 200 sends an instruction to an actual resource transfer server to cause the actual resource transfer server to complete the actual resource transfer in accordance with the virtual resource transfer instruction.

Returning to FIG. 1, in response to receiving the instruction from the terminal device, the actual resource transfer server completes the actual resource transfer in accordance with the instruction. Thus the actual resource transfer is in accordance with the virtual resource transfer instruction. Specifically, the actual resource transfer server transfers actual resource (e.g., money, stocks, funds, securities, properties, or any other type of valuable assets) from an actual-resource account of the user (e.g., a bank account) to an account of the user (e.g., an account for fund products) for revenue-generation activities.

After the actual resource transfer server completes the actual transfer, the actual resource transfer server sends, to the server device and/or the terminal device of the user, respectively, a message indicting the completion of the actual resource transfer. Thus, at S105, the server device receives, from the actual resource transfer server, the message indicating the completion of the actual resource transfer. Similarly, the terminal device of the user receives, from the actual resource transfer server, the message indicating the completion of the actual resource transfer.

FIG. 4 is a schematic diagram illustrating a user interface 410 of the terminal device 2.00 associated with the method 100 in FIG. 1. As shown in FIG. 4, the user interface 410 of the terminal device 200 displays a message 420 confirming the completion of an actual resource transfer. The displayed message 420 includes information of the actual resource transfer such as, for example, a value of the actual resource transferred, an account from which the actual resource is transferred, a time of the transfer, etc. In some embodiments, more or less information of the actual resource transfer than that shown in FIG. 4 can be displayed at a terminal device of a user.

Returning to FIG. 1, at S106, the server device increases, in response to the message from the actual resource transfer server, an account balance of the virtual account of the user by the value of virtual resource to be transferred. The server device then sends, to the terminal device and the account management server, respectively, a message indicating the completion of the virtual resource transfer. In some embodiments, the server device also records information (e.g., value, time) of the virtual resource transfer. Thus, the server device maintains a record of transactions, which includes information of each virtual resource transferred into the virtual account of the user. The server device updates such a record in accordance with each new transaction (e.g., virtual resource transferred into the virtual account of the user).

In some embodiments, the value of the actual resource transferred corresponding to the virtual resource transfer is equal to the value of the virtual resource transferred into the virtual account of the user (i.e., the deduction on the account balance of the virtual account of the user). In other embodiments, the value of the actual resource transferred corresponding to the virtual resource transfer is different than (e.g., more than) the value of the virtual resource transferred into the virtual account of the user (Le., the increase on the account balance of the virtual account of the user). In such embodiments, for example, the value of actual resource transferred can be the value of virtual resource transferred plus a processing fee for performing this transaction.

In some embodiments, an actual-resource account of a user, from which actual resource is transferred, is associated with (e.g., managed and/or supported by), for example, a bank used by the user. Meanwhile, a platform enabling such a virtual resource transfer and a corresponding actual resource transfer is associated with (e,g., owned and/or operated by) a third-party entity (e.g., a company, an organization, an enterprise, an entity). Such a platform can include, for example, the server device, the account management server, and/or other devices, in such embodiments, when the value of the actual resource transferred from the actual-resource account of the user is more than the value of the virtual resource transferred into the virtual account of the user, the difference (e.g., a processing fee) is paid to the third-party entity. For example, when a user uses the platform to purchase a fund product of value X by transferring money from a bank account into a virtual account associated with the fund product, the user needs to pay a processing fee of value Y to the third-party entity that operates the platform. Thus, the deduction from the user's bank account is a value of X plus Y.

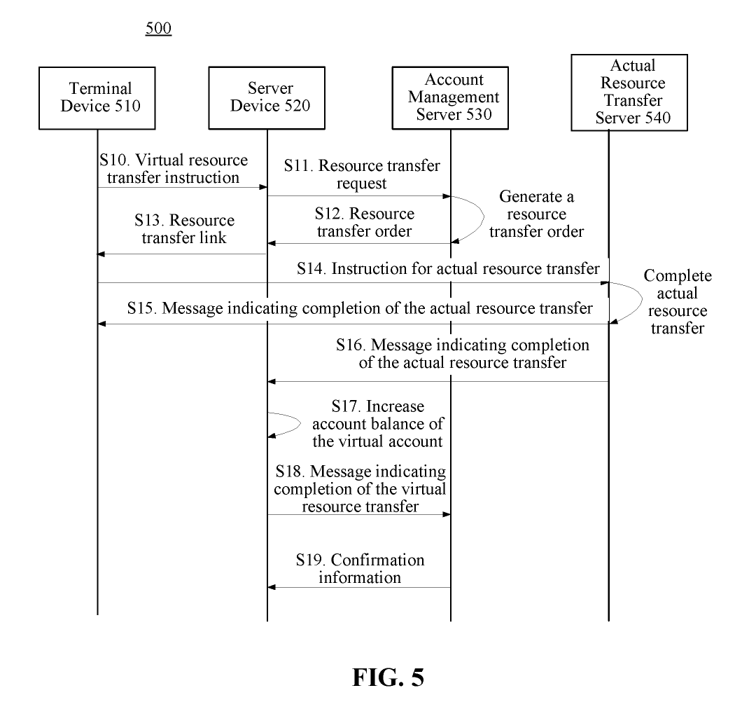

FIG. 5 is a flow chart illustrating a method 500 performed at a system for performing a transaction in accordance with some embodiments. Similar to the system 1500 shown and described above with respect to FIG. 15, the system performing the method 500 includes at least a terminal device 510, a server device 520, an account management server 530 and an actual resource transfer server 540. Each device of the system is similar to its counterpart device of the system 1500 shown and described with respect to FIG. 15. Particularly, the terminal device 510 is operated by a user that uses the system to transfer funds into a virtual account of the user. In some embodiments, more than one terminal device, server device, account management device and/or actual resource transfer server can perform a method similar to the method 500 to perform one or more such transactions for users.

In some embodiments, each of the terminal device 510, the server device 520, the account management server 530 and the actual resource transfer server 540 includes one or more processors and memory. In such embodiments, the method 500 is governed by instructions or code of one or more applications, winch include at least a client-side portion that is stored in and/or executed at the terminal device 510, and one or more server-side portions that are stored in and/or executed at the server device 520, the account management server 530, and/or the actual resource transfer server 540. As a result of the server-side portion(s) of the application and the client-side portion of the application being executed at the server device 520, the account management server 530, the actual resource transfer server 540, and the terminal device 510, respectively, the terminal device 510, the server device 520, the account management server 530 and the actual resource transfer server 540 collectively perform the method 500 to transfer funds into the virtual account of the user. As shown in FIG. 5, the method 500 includes the following steps.

At S10, the terminal device 510 sends a virtual resource transfer instruction to the server device 520. The virtual resource transfer instruction includes a value of virtual resource to be transferred into the virtual account of the user. At least a portion of virtual resource recorded in the virtual account of the user corresponds to actual resource in a different account (e.g., an actual-resource account) of the user used in a revenue-generation activity. Operations of S10 are similar to the operations of S101 of the method 100 described with respect to FIG. 1. In some embodiments, the user operates the terminal device 510 to generate and send the virtual resource transfer instruction to the server device 520, as shown and described with respect to FIG. 2.

In response to the virtual resource transfer instruction, the server device 520 sends a resource transfer request to cause the actual resource transfer server 540 to complete an actual resource transfer in accordance with the virtual resource transfer instruction. The actual resource transfer can be performed in various methods. As an example, 511-514 in the method 500 illustrates one method to perform the actual resource transfer.

Specifically, at S11, the server device 520 sends a resource transfer request to the account management server 530. The resource transfer request includes the value of virtual resource to be transferred into the virtual account of the user. The server device 520 generates the resource transfer request based on data and/or information included in the virtual resource transfer instruction. Operations of S11 are similar to the operations of S102 of the method 100 described with respect to FIG. 1.

At S12, the account management server 530 sends, to the server device 520, a resource transfer order in response to the resource transfer request. As shown in FIG. 5, the account management server 530 generates the resource transfer order based on data and/or information included in the resource transfer request. The resource transfer order includes data and/or information of the actual resource transfer corresponding to the virtual resource transfer in accordance with the Virtual resource transfer instruction. Operations of S12 are similar to the operations of S103 of the method 100 described with respect to FIG. 1.

At S13, the server device 520 sends, to the terminal device 510, a resource transfer link in response to the resource transfer order. In response to receiving the resource transfer link, at S14, the terminal device 510 sends an instruction to the actual resource transfer server 540 to cause the actual resource transfer server 540 to complete the actual resource transfer in accordance with the virtual resource transfer instruction. In some embodiments, the user operates the terminal device 510 to receive and activate the resource transfer link, as shown and described with respect to FIG. 3.

In response to receiving the instruction for actual resource transfer, the actual resource transfer server 540 completes the actual resource transfer accordingly. Specifically, the actual resource transfer server 540 transfers actual resource (e.g., money, stocks, funds, securities, properties, or any other type of valuable assets) from an actual-resource account of the user (e.g., a bank account) to an account of the user (e.g., an account for fund products) for revenue-generation activities.

After the actual resource transfer server 540 completes the actual transfer, at S15, the actual resource transfer server 540 sends, to the terminal device 510, a message indicating completion of the actual resource transfer. Similarly, at S16, the actual resource transfer server 540 sends, to the server device 520, another message indicating completion of the actual resource transfer. Operations of S16 correspond to the operations of S105 of the method 100 described with respect to FIG. 1. In some embodiments, the terminal device 510 receives and displays the message confirming the completion of the actual resource transfer to the user, as shown and described with respect to FIG. 4.

Operations of S17-S18 correspond to the operations of S106 of the method 100 described with respect to FIG. 1. Specifically, at S17, the server device 520 increases the account balance of the virtual account of the user in response to the message from the actual resource transfer server 540. In some embodiments, the account balance of the virtual account of the user is increased by the value of virtual resource to be transferred in accordance with the virtual resource transfer instruction. At S18, the server device 520 sends, to the account management server 530, a message indicating completion of the virtual resource transfer. In some embodiments, although not shown in FIG. 5, the server device 520 also sends, to the terminal device 510, a message indicating completion of the virtual resource transfer. In some embodiments, the server device 520 also records information (e.g., value, time of the virtual resource transfer. Thus, the server device 520 maintains and updates a record of transactions, which includes information of each virtual resource transferred into the virtual account of the user. At S19, the account management server 530 sends confirmation information to the server device 520.

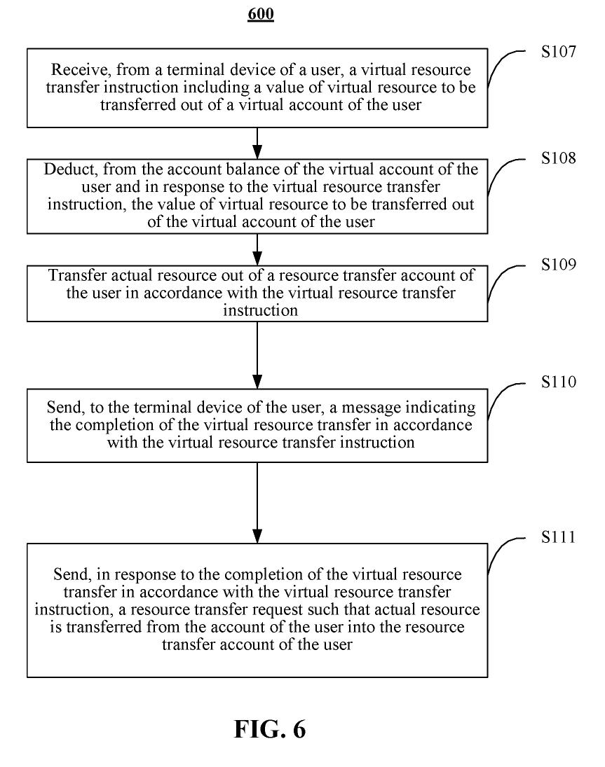

FIG. 6 is a flow chart illustrating another method 600 performed at a server device for performing a transaction in accordance with some embodiments. The server device performing the method 600 can be similar to the server device 1502 shown and described with respect to FIG. 15. Particularly, the server device performing the method 600 is operatively coupled to at least a terminal device of a user (e.g., the terminal device 1508 or 1501 in FIG. 15), an account management server (e.g., the account management server 1504 in FIG. 15) and an actual resource transfer server (e.g., the actual resource transfer server 1503 in FIG. 15). The server device, the terminal device, the account management server and the actual resource transfer server can collectively perform a transaction to transfer funds out of a virtual account of the user.

In some embodiments, the server device performing the method 600 can be the same server device that performs the method 100 in FIG. 1. In such embodiments, after the server device performs the method 100 to transfer funds into the virtual account of the user, the server device can subsequently perform the method 600 to transfer funds out of the virtual account of the user. In some embodiments, the server device performs the method 100 (i.e., transferring funds into the virtual account of the user) when the user deposits virtual resource into the virtual account, which corresponds to depositing actual resource (e.g., valuable assets) into an actual-resource account of the user that is used for revenue-generation activities (e.g., invest in stock market, purchase fund products, etc.). On the contrary, the server device performs the method 600 (i.e., transferring funds out of the virtual account of the user) when the user withdraws virtual resource from the virtual account, which corresponds to withdrawing actual resource from the actual-resource account of the user that is used for revenue-generation activities. The user can use the withdrawn actual resource for consumption activities (e.g., make a purchase, make a payment, etc.).

In some embodiments, the server device performing the method 600 can include one or more processors and memory. In such embodiments, the method 600 is governed by instructions or code of an application that are stored in a non-transitory computer readable storage medium of the server device and executed by the one or more processors of the server device. The application is associated with transferring funds out of the virtual account of the user. Such an application typically has a server-side portion that is stored in and/or executed at the server device, and a client-side portion that is stored in and/or executed at the terminal device operated by the user. As a result of the server-side portion of the application being executed, the method 600 is performed at the server device. As shown in FIG. 6, the method 600 includes the following steps.

At S107, the server device receives, from the terminal device of the user, a virtual resource transfer instruction including a value of virtual resource to be transferred out of the virtual account of the user. At least a portion of virtual resource recorded in the virtual account of the user corresponds to actual resource in the actual-resource account of the user, which is used in a revenue-generation activity. The virtual resource transferred out of the virtual account of the user corresponds to actual resource that is withdrawn from the actual-resource account and is to be used by the user in a consumption activity. For example, the user operates the terminal device to withdraw money from an account associated with a fund product, and to use the withdrawn money to make a payment or a purchase. Correspondingly, the user operates the terminal device to deduct virtual resource (corresponding to the money withdrawn) from the account balance of the virtual account of the user.

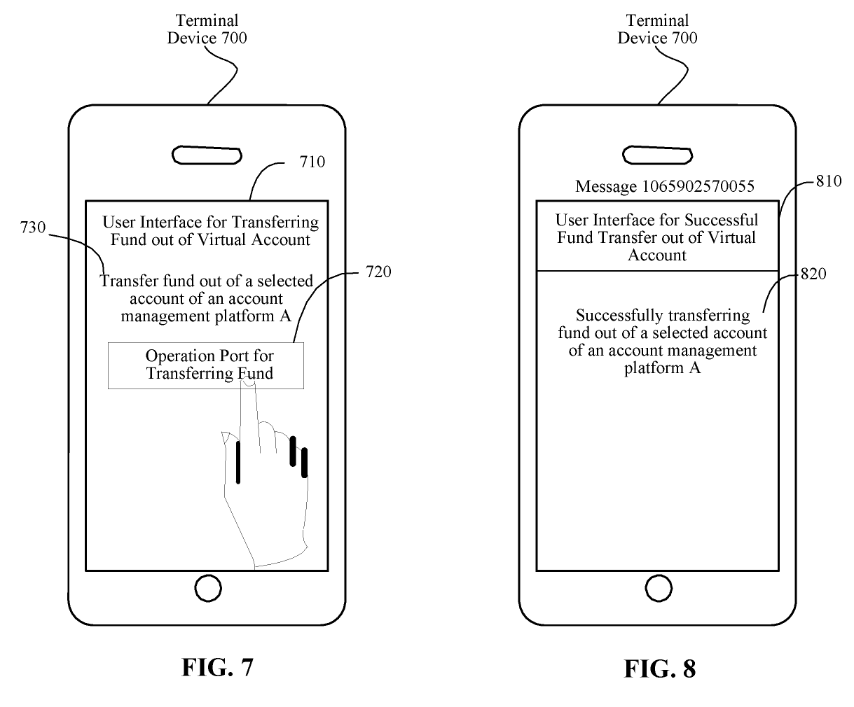

FIG. 7 is a schematic diagram illustrating a user interface 710 of a terminal device 700 associated with the method 600 in FIG. 6. The terminal device 700 can be operated by a user and can be similar to the terminal device described above with respect to performing the method 600 in FIG. 6. As shown in FIG. 7, the user interface 710 of the terminal device 700 displays a message 730 that prompts the user to activate the operation port for transferring fund by clicking the button 720. As a result of the user clicking the button 720, the terminal device 700 sends a virtual resource transfer instruction to a server device communicating with the terminal device 700.

In some embodiments, after the user clicks the button 720 to activate the operation port for transferring fund, the terminal device 700 displays another user interface (not shown in FIG. 7) for the user to enter data and/or information of the intended transaction. Specifically, the user can be prompted to, for example, select a virtual account (corresponding to an actual-resource account associated with actual resource used in revenue-generation activities) from which the virtual resource is transferred, select an account (e.g., an online payment account) into which the actual resource is transferred, enter a value of virtual resource to be transferred, and/or the like. The terminal device 700 then generates a virtual resource transfer instruction based on the entered data and/or information, and then sends the virtual resource transfer instruction to the server device communicating with the terminal device 700.

Returning to FIG. 6, at S108, the server device deducts, from the account balance of the virtual account of the user and in response to the virtual resource transfer instruction, the value of virtual resource to be transferred out of the virtual account of the user. The server device manages the virtual account of the user. In other words, the server device can increase and decrease the account balance of the virtual account based on a request, instruction, command or order received at the server device. For example, as described in the method 100 with respect to FIG. 1, the server device can increase the account balance of the virtual account in response to a message from the actual resource transfer server that indicates the completion of an actual resource transfer. For another example, as illustrated herein, the server device can decrease the account balance of the virtual account in response to the virtual resource transfer instruction received from the terminal device.

In some embodiments, the server device determines if the virtual account has sufficient balance for a required transfer. In such embodiments, if the virtual account does not have enough balance for the required transfer (i.e., the account balance of the virtual account is less than the value of virtual resource to be transferred), the server device can, for example, send an alert message to the terminal device, which then can alert the user of the insufficient balance (not shown in FIG. 6).

At S109, the server device transfers actual resource out of a resource transfer account of the user in accordance with the virtual resource transfer instruction. The value of the actual resource transferred out of the resource transfer account can be equal to the value of virtual resource deducted from the account balance of the virtual account. In other words, in response to the virtual resource transfer request, the user withdraws actual resource from the resource transfer account. In some embodiments, as described above, the actual resource withdrawn by the user can be used in a consumption activity such as making an online payment, purchasing merchandise, and/or the like. In some other embodiments, the actual resource withdrawn by the user can be transferred into another account (e.g., a bank account) of the user. In such embodiments, the actual resource is transferred from the resource transfer account of the user into the target account of the user.

In some embodiments, the resource transfer account of the user maintains an account balance of actual resource that is at least as high as the account balance of the virtual account of the user. Thus, the resource transfer account has sufficient actual resource to handle any withdraw request associated with a transaction that transfers virtual resource out of the virtual account of the user. Furthermore, in some embodiments, more than one virtual account (of the same user or different users) can share a common resource transfer account. In such embodiments, the common resource transfer account can function as a pool for the multiple virtual accounts. That is, actual resource can be withdrawn from the common resource transfer account in response to virtual resource being transferred out of any of the virtual accounts.

In some embodiments, as described below, the actual resource withdrawn from the resource transfer account in response to a virtual resource transfer initiated by a user can be fully compensated by redemption from an actual-resource account of that user. As a result, the resource transfer account can maintain a certain level of balance after each transaction. Such a certain level of balance of the resource transfer account is typically at least as high as the account balance of each virtual account linked to the resource transfer account. Thus, at any given time, the resource transfer account has sufficient actual resource to complete at least one withdrawal associated with a virtual account linked to that resource transfer account.

Furthermore, in some embodiments, the resource transfer account is not owned by any particular user. Instead, the resource transfer account is associated with a third-party entity that owns and/or operates the platform enabling such virtual resource transfers and corresponding actual resource transfers, as described above with respect to FIG. 1. In such embodiments, in response to a virtual resource transfer (i.e., virtual resource transferred out of a virtual account) initiated by a user, actual resource is withdrawn from the resource transfer account and used by the user (e.g., for consumption activities). Subsequently, as described below, actual resource is redeemed from an actual-resource account (e.g., a bank account) of that user and transferred into the resource transfer account. Thus, a transaction is completed and the resource transfer account is compensated accordingly.

At S110, the server device sends, to the terminal device of the user, a message indicating the completion of the virtual resource transfer in accordance with the virtual resource transfer instruction. FIG. 8 is a schematic diagram illustrating a user interface 810 of the terminal device 700 associated with the method 600 in FIG. 6. As shown in FIG. 8, the user interface 810 of the terminal device 700 displays a message 820 confirming the completion of a virtual resource transfer (i.e., successfully transferring fund out of a selected account of an account management platform A). In some embodiments, a displayed message can include information of the virtual resource transfer such as, for example, a value of the virtual resource transferred (not shown in FIG. 8), an account from which the virtual resource is transferred (e.g., the selected account of the account management platform A), a time of the transfer (not shown in FIG. 8), etc.

Returning to FIG. 6, at S111, the server device sends, in response to the completion of the virtual resource transfer in accordance with the virtual resource transfer instruction, a resource transfer request such that actual resource is transferred from the account of the user into the resource transfer account of the user. The resource transfer request includes a value of actual resource to be transferred. The account of the user, from which the actual resource is transferred, is an actual-resource account of the user that manages actual resource used in revenue-generation activities. In some embodiments, such a process performed at S111 is referred to as redemption.

In some embodiments, the value of actual resource transferred from the actual-resource account of the user to the resource transfer account is equal to the value of actual resource withdrawn from the resource transfer account (at S109), which is equal to the value of virtual resource deducted from the account balance of the virtual account of the user (at S108). In some other embodiments, as described above with respect to FIG. 1, the value of actual resource transferred from the actual-resource account of the user to the resource transfer account is equal to a sum of the value of actual resource withdrawn from the resource transfer account (which is equal to the value of virtual resource deducted from the account balance of the virtual account of the user) plus, for example, a processing fee. Such a processing fee is paid to the third-party entity that owns and/or operates the platform, which includes, for example, the server device, the account management server, the actual resource transfer server, and/or other devices.

In some embodiments, to perform the redemption at S111, the server device can send the resource transfer request to the account management server. In response to receiving the resource transfer request, the account management server can transfer the actual resource from the actual-resource account of the user into the resource transfer account of the user in accordance with the virtual resource transfer instruction.

In performing the method 600, the user acquires actual resource from the recourse transfer account (at S109) without interacting with the account management server to withdraw actual resource from the actual-resource account of the user (at S111). Similarly stated, the user first “borrows” actual resource from the resource transfer account for consumption use, and then “pays back” actual resource from the actual-resource account of the user into the resource transfer account at a later time. In such a method, the user can withdraw and use actual resource associated with the virtual account of the user (e.g., for consumption activities) in a substantially real-time manner, without spending time on interacting with the account management server to withdraw actual resource from the user's account for revenue-generation activities. Furthermore, as described above, the value of the actual resource “paid back” into the resource transfer account is at least as high as the value of the actual resource “borrowed” from the resource transfer account.

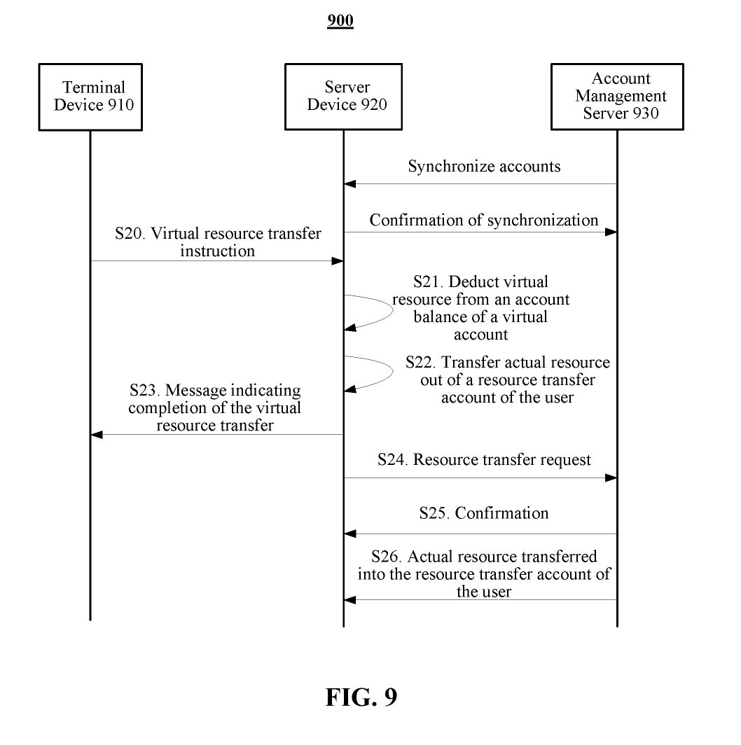

FIG. 9 is a flow chart illustrating a method 900 performed at a system for transferring fund out of a virtual account of a user in accordance with some embodiments. Similar to the system 1500 shown and described above with respect to FIG. 15, the system performing the method 900 includes at least a terminal device 910, a server device 920 and an account management server 930. Each device of the system is similar to its counterpart device of the system 1500 shown and described with respect to FIG. 15. Particularly, the terminal device 910 is operated by the user that uses the system to transfer funds out of (in other words, withdraw funds from) the virtual account of the user. In some embodiments, more than one terminal device, server device and/or account management device can perform a method similar to the method 900 to perform one or more such transactions for users. In some embodiments, the terminal device 910, the server device 920 and the account management server device 930 can be the same as the counterpart devices that collectively perform the method 500 in FIG. 5. In such embodiments, the method 900 can be performed subsequently to the method 500.

In some embodiments, the server device 920 and the account management server 930 collectively manage virtual account and corresponding actual-resource account of the user. Specifically, the server device 920 manages the virtual account and the account management server 930 manages the corresponding actual-resource account. The server device 920 and the account management server 930 can interact with each other to synchronize the two accounts, such that the virtual resource recorded in the virtual account is maintained as an accurate reflection of the actual resource in the actual-resource account. Such synchronization operations can be performed in any suitable method according to any suitable schedule (e.g., triggered by an event, according to a predefined periodic schedule, etc.).

For example, as shown in FIG. 9, after the value of the actual resource in the actual-resource account is changed, the account management server 930 sends a synchronizing message to the server device 920. The synchronizing message includes an updated value and/or other information of the actual resource in the actual-resource account. In response to receiving the synchronizing message, the server device 920 modifies the recorded value of virtual resource accordingly. Additionally, the server device 920 sends a confirmation message back to the account management server 930, confirming the completion of synchronization.

In some embodiments, each of the terminal device 910, the server device 920 and the account management server 930 includes one or more processors and memory. In such embodiments, the method 900 is governed by instructions or code of one or more applications, which include at least a client-side portion that is stored in and/or executed at the terminal device 910, and one or more server-side portions that are stored in and/or executed at the server device 920 and/or the account management server 930. As a result of the server-side portion(s) of the application and the client-side portion of the application being executed at the server device 920, the account management server 930, and the terminal device 910, respectively, the terminal device 910, the server device 920 and the account management server 930 collectively perform the method 900 to transfer funds into the virtual account of the user. As shown in FIG. 9, the method 900 includes the following steps.

At S20, the terminal device 910 sends a virtual resource transfer instruction to the server device 920. The virtual resource transfer instruction includes a value of virtual resource to be transferred out of the virtual account of the user. At least a portion of virtual resource recorded in the virtual account of the user corresponds to actual resource in a different account (e.g., an actual-resource account) of the user used in a revenue-generation activity. Operations of S20 are similar to the operations of S107 of the method 600 described with respect to FIG. 6. In some embodiments, the user operates the terminal device 910 to generate and send the virtual resource transfer instruction to the server device 920, as shown and described with respect to FIG. 7.

At S21, the server device 920 deducts, from the account balance of the virtual account of the user and in response to the virtual resource transfer instruction, the value of virtual resource to be transferred out of the virtual account of the user. The server device 920 manages the virtual account of the user. In some embodiments, the server device 920 determines if the virtual account has sufficient balance for the required transfer. In such embodiments, if the virtual account does not have enough balance for the required transfer (i.e., the account balance of the virtual account is less than the value of virtual resource to be transferred), the server device 920 can, for example, send an alert message to the terminal device 910, which then can alert the user of the insufficient balance (not shown in FIG. 9). Operations of S21 are similar to the operations of S108 of the method 600 described with respect to FIG. 6.

At S22, the server device 920 transfers actual resource out of a resource transfer account of the user in accordance with the virtual resource transfer instruction. The value of the actual resource transferred out of the resource transfer account can be equal to the value of virtual resource deducted from the account balance of the virtual account. In some embodiments, as described above, the actual resource withdrawn by the user can be used in a consumption activity or transferred into another account of the user. Operations of S22 are similar to the operations of S109 of the method 600 described with respect to FIG. 6.

At S23, the server device 920 sends, to the terminal device 910, a message indicating the completion of the virtual resource transfer in accordance with the virtual resource transfer instruction. Operations of S23 are similar to the operations of S110 of the method 600 described with respect to FIG. 6. In sonic embodiments, the terminal device 910 receives and displays the message confirming the completion of the virtual resource transfer to the user, as shown and described with respect to FIG. 8.

In response to the completion of the virtual resource transfer in accordance with the virtual resource transfer instruction, the server device 920 sends a resource transfer request such that actual resource is transferred from an actual-resource account (which manages actual resource of the user used in revenue-generation activities) of the user into the resource transfer account of the user. Such an actual resource transfer can be performed in any suitable method. As an example, S24-S26 illustrate a method for performing the actual resource transfer. Operations of S24-S26 are similar to the operations of S111 of the method 600 described with respect to FIG. 6.

Specifically, at S24, the server device 920 sends a resource transfer request to the account management server 930. The resource transfer request includes the value of actual resource to be transferred. As described above, such a value can be at least as high as the value of virtual resource deducted from the account balance of the virtual account (at S21). At S25, the account management server 930 sends, to the server device 920, a confirmation in response to the resource transfer request. At S26, the account management server 930 manages to transfer actual resource into the resource transfer account of the user. As described above with respect to FIG. 6, the actual resource is transferred from an actual-resource account of the user that manages actual resource used in revenue-generation activities. Furthermore, the value of actual resource redeemed (i.e., transferred into the resource transfer account) is at least as high as the value of virtual resource deducted from the account balance of the virtual account.

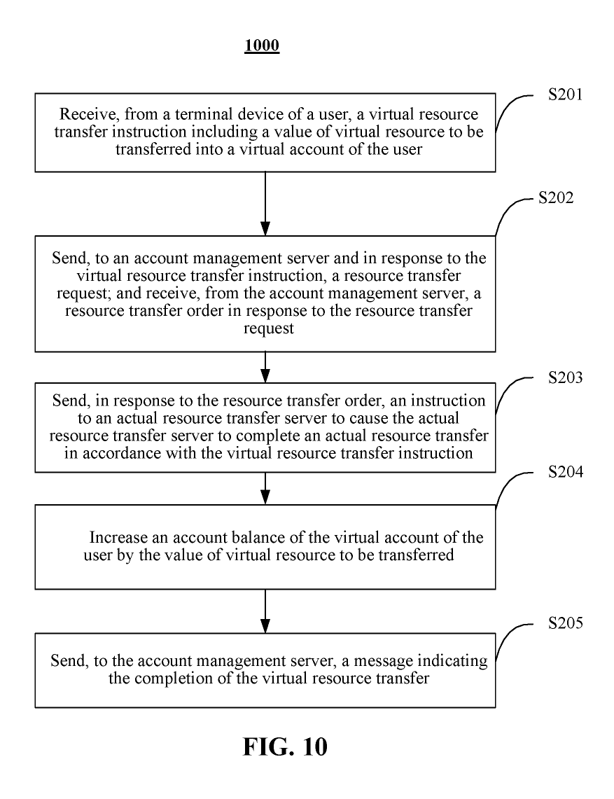

FIG. 10 is a flow chart illustrating a method 1000 performed at a server device for transferring fund into a virtual account in accordance with some embodiments. The server device performing the method 1000 can be similar to the server device 1502 shown and described with respect to FIG. 15. Particularly, the server device performing the method 1000 is operatively coupled to at least a terminal device of a user (e.g., the terminal device 1508 or 1501 in FIG. 15), an account management server (e.g., the account management server 1504 in FIG. 15) and an actual resource transfer server (e.g., the actual resource transfer server 1503 in FIG. 15). The server device, the terminal device, the account management server and the actual resource transfer server can collectively perform a transaction to transfer funds into a virtual account of the user.

In some embodiments, the server device performing the method 1000 can include one or more processors and memory. In such embodiments, the method 1000 is governed by instructions or code of an application that are stored in a non-transitory computer readable storage medium of the server device and executed by the one or more processors of the server device. The application is associated with transferring funds into the virtual account of the user. Such an application typically has a server-side portion that is stored in and/or executed at the server device, and a client-side portion that is stored in and/or executed at the terminal device operated by the user. As a result of the server-side portion of the application being executed, the method 1000 is performed at the server device. As shown in FIG. 10, the method 1000 includes the following steps.

At S201, the server device receives, from the terminal device of the user, a virtual resource transfer instruction including a value of virtual resource to be transferred into the virtual account of the user. At least a portion of virtual resource recorded in the virtual account of the user corresponds to actual resource in a different account (e.g., an actual-resource account) of the user used in a revenue-generation activity. Operations of S201 correspond to the operations of S10 of the method 500 described with respect to FIG. 5. In some embodiments, the user operates the terminal device to generate and send the virtual resource transfer instruction to the server device, as shown and described with respect to FIG. 2.

At S202, the server device sends, to the account management server and in response to the virtual resource transfer instruction, a resource transfer request. The server device receives, from the account management server, a resource transfer order in response to the resource transfer request. The resource transfer request includes the value of virtual resource to be transferred into the virtual account of the user. The server device generates the resource transfer request based on data and/or information included in the virtual resource transfer instruction. The account management server generates the resource transfer order based on data and/or information included in the resource transfer request. The resource transfer order includes data and/or information of the actual resource transfer corresponding to the virtual resource transfer in accordance with the virtual resource transfer instruction. Operations of S202 correspond to the operations of S11-S12 of the method 500 described with respect to FIG. 5.

At S203, the server device sends, in response to the resource transfer order, an instruction to the actual resource transfer server to cause the actual resource transfer server to complete an actual resource transfer in accordance with the virtual resource transfer instruction. As a result, the actual resource transfer server transfers actual resource into the actual-resource account of the user, which corresponds to the virtual account of the user and records actual resource used in revenue-generation activities. Furthermore, in response to completing the actual resource transfer, the actual resource transfer can send a message, to the server device and/or the terminal device of the user, indicating completion of the actual resource transfer.

In some embodiments, as shown and described in the methods 100, 500 with respect to FIGS. 1 and 5, the server device sends, to the terminal device of the user, a link (e.g., a payment link) associated with the actual resource transfer. In response to receiving the link, the terminal device of the user sends an instruction to the actual resource transfer server to cause the actual resource transfer server to complete the actual resource transfer in accordance with the virtual resource transfer instruction. Such operations correspond to the operations of S13-S16 of the method 500 described with respect to FIG. 5. In some other embodiments, although not shown in FIG. 5, the server device can send the instruction to the actual resource transfer server without using the terminal device of the user. For example, the server device can send the instruction directly to the actual resource transfer server to trigger the actual resource transfer.

At S204, the server device increases an account balance of the virtual account of the user by the value of virtual resource to be transferred. Operations of S204 correspond to the operations of S17 of the method 500 described with respect to FIG. 5. Subsequently, at S205, the server device sends, to the account management server, a message indicating the completion of the virtual resource transfer. Operations of S205 correspond to the operations of S18 of the method 500 described with respect to FIG. 5.

Furthermore, in some embodiments, the server device also sends, to the terminal device of the user, a message indicating completion of the virtual resource transfer. In some embodiments, the server device records information (e.g., value, time) of the virtual resource transfer. Thus, the server device maintains and updates a record of transactions, which includes information of each virtual resource transferred into the virtual account of the user. Additionally, in some embodiments, the account management server sends confirmation information to the server device in response to the message from the server device.

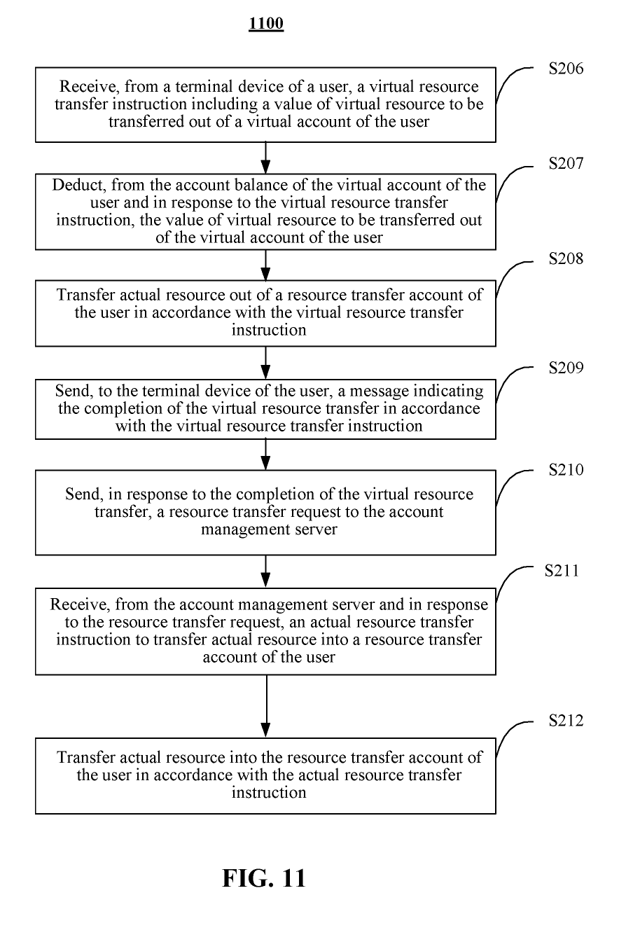

FIG. 11 is a flow chart illustrating a method 1100 performed at a server device for transferring fund out of a Virtual account in accordance with some embodiments. The server device performing the method 1100 can be similar to the server device 1502 shown and described with respect to FIG. 15. Particularly, the server device performing the method 1000 is operatively coupled to at least a terminal device of a user (e.g., the terminal device 1508 or 1501 in FIG. 15) and an account management server (e.g., the account management server 1504 in FIG. 15). The server device, the terminal device and the account management server can collectively perform a transaction to transfer funds out of a virtual account of the user. In some embodiments, the server device performing the method 1100 can be the same as the server device performing the method 1000 in FIG. 10. In such embodiments, the method 1100 can be performed subsequently to the method 1000.

In some embodiments, the server device performing the method 1100 can include one or more processors and memory. In such embodiments, the method 1100 is governed by instructions or code of an application that are stored in a non-transitory computer readable storage medium of the server device and executed by the one or more processors of the server device. The application is associated with transferring funds out of the virtual account of the user. Such an application typically has a server-side portion that is stored in and/or executed at the server device, and a client-side portion that is stored in and/or executed at the terminal device operated by the user. As a result of the server-side portion of the application being executed, the method. 1100 is performed at the server device. As shown in FIG. 11, the method 1100 includes the following steps.

At S206, the server device receives, from the terminal device of the user, a virtual resource transfer instruction including a value of virtual resource to be transferred out of the virtual account of the user. At least a portion of virtual resource recorded in the virtual account of the user corresponds to actual resource in an actual-resource account of the user that manages actual resource used in a revenue-generation activity. Operations of S206 correspond to the operations of S20 of the method 900 described with respect to FIG. 9. In some embodiments, the user operates the terminal device to generate and send the virtual resource transfer instruction to the server device, as shown and described with respect to FIG. 7.

At S207, the server device deducts, from the account balance of the virtual account of the user and in response to the virtual resource transfer instruction, the value of virtual resource to be transferred out of the virtual account of the user. The server device manages the virtual account of the user. In some embodiments, the server device determines if the virtual account has sufficient balance for the required transfer. In such embodiments, if the virtual account does not have enough balance for the required, the server device can, for example, send an alert message to the terminal device of the user, which then can alert the user of the insufficient balance. Operations of S207 correspond to the operations of S21 of the method 900 described with respect to FIG. 9.

At S208, the server device transfers actual resource out of a resource transfer account of the user in accordance with the virtual resource transfer instruction. The value of the actual resource transferred out of the resource transfer account can be equal to the value of virtual resource deducted from the account balance of the virtual account. In some embodiments, as described above, the actual resource withdrawn by the user can be used in a consumption activity or transferred into another account of the user. Operations of S208 correspond to the operations of S22 of the method 900 described with respect to FIG. 9.

At S209, the server device sends, to the terminal device of the user, a message indicating the completion of the virtual resource transfer in accordance with the virtual resource transfer instruction. Operations of S209 correspond to the operations of S23 of the method 900 described with respect to FIG. 9. In some embodiments, the terminal device of the user receives and displays the message confirming the completion of the virtual resource transfer to the user, as shown and described with respect to FIG. 8.

In response to the completion of the virtual resource transfer in accordance with the virtual resource transfer instruction, the server device sends a resource transfer request such that actual resource is transferred from the actual-resource account of the user (which manages actual resource of the user used in revenue-generation activities) into the resource transfer account of the user. Such an actual resource transfer can be performed in any suitable method. As an example, S210-212 illustrate a method for performing the actual resource transfer.

Specifically, at S210, the server device sends, in response to the completion of the virtual resource transfer, a resource transfer request to the account management server. The resource transfer request includes the value of actual resource to be transferred. As described above, such a value can be at least as high as the value of virtual resource deducted from the account balance of the virtual account (at S207). At S211, the server device receives, from the account management server and in response to the resource transfer request, an instruction to transfer actual resource into a resource transfer account of the user. At S212, the server device transfers actual resource into the resource transfer account of the user in accordance with the actual resource transfer instruction. As a result, the actual resource is transferred from the actual-resource account of the user that manages actual resource used in revenue-generation activities, into the resource transfer account of the user. Furthermore, the value of actual resource redeemed (i.e., transferred into the resource transfer account) is at least as high as the value of virtual resource deducted from the account balance of the virtual account.

FIG. 12 is a block diagram illustrating modules of a server device 1200 configured to transfer funds in accordance with some embodiments. The server device 1200 can be structurally and functionally similar to the server devices shown and/or described with respect to FIGS. 1-11 and 15. The server device 1200 can be operatively coupled to and communicate with at least a terminal device operated by a user (e.g., the terminal device 1501 or 1508 operated by the user 1509 in FIG. 15), an account management server (e.g., the account management server 1504 in FIG. 15) and an actual resource transfer server (e.g., the actual resource transfer server 1503 in FIG. 15). As shown in FIG. 12, the server device 1200 includes a receiving module 1201, a request module 1202, a transfer module 1203, a recording module 1204 and a notify module 1205. In some embodiments, a server device can include more or less modules than those shown in FIG. 12.

In some embodiments, each module included in the server device 1200 can be a hardware-based module (e.g., a digital signal processor (DSP), an application-specific integrated circuit (ASIC), a field programmable gate array (FPGA), etc.), a software-based module (e.g., a module of computer code executed at a processor, a set of processor-readable instructions executed at a processor, etc.), or a combination of hardware and software modules. Instructions or code of each module can be stored in a memory of the server device 1200 (not shown in FIG. 12) and executed at a processor (e.g., a CPU) of the server device 1200 (not shown in FIG. 12). Overall, the receiving module 1201, the request module 1202, the transfer module 1203, the recording module 1204 and the notify module 1205 can be configured to collectively perform at least a portion (e.g., a server-side portion) of the methods 100, 500 and 1000 shown and described above with respect to FIGS. 1, 5 and 10. In other words, the receiving module 1201, the request module 1202, the transfer module 1203, the recording module 1204 and the notify module 1205 can be configured to collectively transfer funds (e.g., virtual resource) into a virtual account of the user.

Specifically, the receiving module 1201 is configured to, among other functions, receive virtual resource transfer instructions sent from the terminal device of the user. In some embodiments, the receiving module 1201 is also configured to receive other types of instructions, commands, requests, messages, and/or the like. For example, as described above with respect to FIG. 5, the receiving module 1201 can receive resource transfer orders, messages indicating completion of transfers (e.g., actual resource transfers), synchronizing messages, confirmation messages, etc.

The request module 1202 is configured to, among other functions, generate and send resource transfer requests to the account management server. The request module 1202 can generate a resource transfer request based on data and/or information (e.g., the value of virtual resource to be transferred into the virtual account) of the virtual resource transfer that is retrieved from a corresponding virtual resource transfer instruction.

The transfer module 1203 is configured to, among other functions, perform actual resource transfers. In some embodiments, the transfer module 1203 can be configured to cause the actual resource transfer server to complete the actual resource transfer in accordance with the virtual resource transfer instruction. Specifically, as shown and described with respect to FIG. 5, the transfer module 1203 can generate and send a resource transfer link (e.g., a payment link as in FIG. 3) to the terminal device, which prompts the user to click the resource transfer link. As a result, the terminal device sends an instruction for actual resource transfer to the actual resource transfer server, causing the actual resource transfer server to complete the actual resource transfer. Although not shown in FIG. 5, in other embodiments, the transfer module 1203 can be configured to perform the actual resource transfer in other suitable method.

The recording module 1204 is configured to, among other functions, manage the virtual account of the user. Specifically, the recording module 1204 is configured to updates (e.g., increase, decrease) the account balance of the virtual account in accordance with the corresponding actual resource transfer. Furthermore, the recording module 1204 can be configured to record information (e.g., value, time) of virtual resource transfers, thus maintaining a record of transactions. Such a record of transaction can include, for example, information of each virtual resource transferred into the virtual account of the user.

The notify module 1205 is configured to, among other functions, notify the completion of virtual resource transfers to, for example, the account management server and/or the terminal device of the user. Specifically, the notify module 1205 can be configured to generate and send a message indicating completion of a virtual resource transfer to the account management server or the terminal device of the user.

FIG. 13 is a block diagram illustrating modules of another server device 1300 configured to transfer funds in accordance with some embodiments. The server device 1300 can be structurally and functionally similar to the server devices shown and/or described with respect to FIGS. 1-11 and 15. The server device 1300 can be operatively coupled to and communicate with at least a terminal device operated by a user (e.g., the terminal device 1501 or 1508 operated by the user 1509 in FIG. 15) and an account management server (e.g., the account management server 1504 in FIG. 15). As shown in FIG. 13, the server device 1300 includes a receiving module 1301, a deduction module 1302, a notify module 1303, an operation module 1304 and a transfer module 1305. In some embodiments, a server device can include more or less modules than those shown in FIG. 13.

Similar to the server device 1200 in FIG. 12, each module included in the server device 1300 can be a hardware-based module (e.g., a DSP, an ASIC, a FPGA, etc.), a software-based module (e.g., a module of computer code executed at a processor, a set of processor-readable instructions executed at a processor, etc.), or a combination of hardware and software modules. Instructions or code of each module can be stored in a memory of the server device 1300 (not shown in FIG. 13) and executed at a processor (e.g., a CPU) of the server device 1300 (not shown in FIG. 13). Overall, the receiving module 1301, the deduction module 1302, the notify module 1303, the operation module 1304 and the transfer module 1305 can be configured to collectively perform at least a portion (e.g., a server-side portion) of the methods 600, 900 and 1100 shown and described above with respect to FIGS. 6, 9 and 11. In other words, the receiving module 1301, the deduction module 1302, the notify module 1303, the operation module 1304 and the transfer module 1305 can be configured to collectively transfer funds (e.g., virtual resource) out of a virtual account of the user.

Specifically, similar to the receiving module 1201 of the server device 1200, the receiving module 1301 is configured to, among other functions, receive virtual resource transfer instructions sent from the terminal device of the user. In sonic embodiments, the receiving module 1301 is also configured to receive other types of instructions, commands, requests, messages, and/or the like. For example, as described above with respect to FIG. 9, the receiving, module 1301 can receive instructions for actual resource transfer, synchronizing messages, confirmation messages, etc.

Similar to the recording module 1204 of the server device 1200, the deduction module 1302 is configured to, among other functions, deduct the account balance of the virtual account of the user. Specifically, the deduction module 1302 is configured to deduct the account balance of the virtual account in accordance with the corresponding actual resource transfer, where actual resource is transferred out of the actual-resource account of the user that manages actual resource used for revenue-generation activities.

Similar to the notify module 1205 of the server device 1200, the notify module 1303 is configured to, among other functions, notify the completion of virtual resource transfers to, for example, the account management server and/or the terminal device of the user. Specifically, the notify module 1303 can be configured to generate and send a message indicating completion of a virtual resource transfer to the account management server or the terminal device of the user.

Similar to the request module 1202 of the server device 1200, the operation module 1304 is configured to, among other functions, interact with the account management server to perform actual resource transfers. Specifically, as shown and described with respect to FIG. 9, the operation module 1304 can be configured to generate and send resource transfer requests to the account management server, causing the account management server to initiate the actual resource transfer in accordance with the corresponding resource transfer request.

Similar to the transfer module 1203 of the server device 1200, the transfer module 1305 is configured to, among other functions, perform actual resource transfers. In some embodiments, as describe with respect to FIG. 11, the transfer module 1305 can be configured to transfer actual resource into the resource transfer account in accordance with an actual resource transfer instruction received from the account management server.

The server device 1300 can be structurally and functionally similar to the server device 1200 shown and described with respect to FIG. 12. In some embodiments, functionalities of the server device 1200 and the server device 1300 can be combined and implemented in a single server device. In such embodiments, a module of the server device 1200 and a module of the server device 1300, as shown and described herein, can be combined into a common module of the single server device. For example, the receiving module 1201 of the server device 1200 can be combined with the receiving module 1301 of the server device 1300; the request module 1202 of the server device 12.00 can be combined with the operation module 1304 of the server device 1300; the transfer module 1203 of the server device 1200 can be combined with the transfer module 1305 of the server device 1300; the recording module 1204 of the server device 1200 can be combined with the deduction module 1302 of the server device 1300; and the notify module 1205 of the server device 1200 can be combined with the notify module 1303 of the server device 1300. Thus, such a single server device can be configured to perform both a method for transferring virtual resource into the virtual account of the user (e.g., the methods 100, 500 and 1000 in FIGS. 1, 5 and 10), and a method for transferring virtual resource out of the virtual account of the user (e.g., the methods 600, 900 and 1100 in FIGS. 6, 9 and 11).

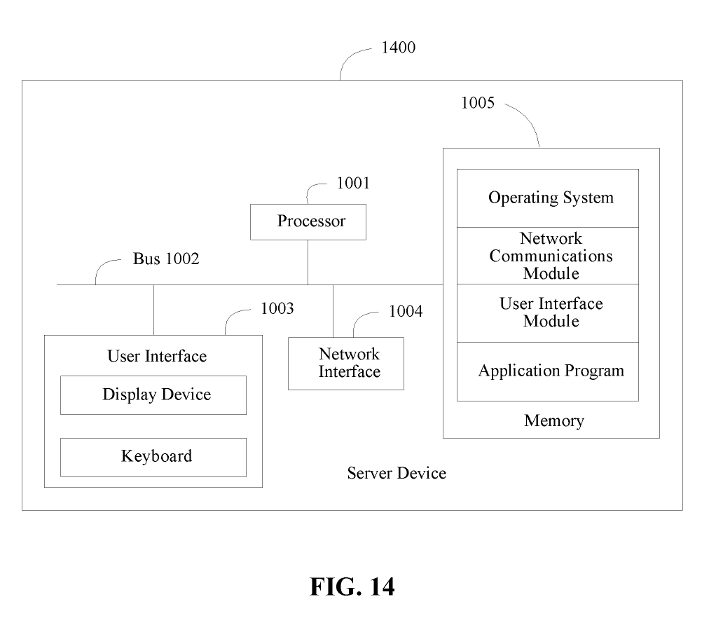

FIG. 14 is a schematic diagram illustrating components of a server device 1400 configured to transfer funds in accordance with some embodiments. The server device 1400 can be structurally and functionally similar to the server devices shown and described above with respect to FIGS. 1-13 and 15. As shown in FIG. 14, the server device 1400 includes a processor 1001, a bus 1002, a user interface 1003, a network interface 1004, and a memory 1005. In some embodiments, a server device can include more or less devices, components and/or modules than those shown in FIG. 14.

The processor 1001 can be any processing device capable of performing at least a portion (e.g., a server-side portion) of the methods 100, 500-600, and 900-1100 described with respect to FIGS. 1-11. Such a processor can be, for example, a CPU, a DSP, an ASIC, a FPGA, and/or the like. The processor 1001 can be configured to control the operations of other components and/or modules of the server device 1400. For example, the processor 1001 can be configured to control operations of the network interface 1004 and the user interface 1003. For another example, the processor 1001 can be configured to execute instructions or code stored in a software program or module (e.g., a resource-transfer application) within the memory 1005.

The bus 1002 is configured to implement connections and communication among the other components of the server device 1400. The user interface 1003 is configured to interact with users operating the server device 1400 by using various input/output means. As shown in FIG. 14, the user interface 1003 includes at least a display device and a keyboard. The display screen is configured to display data and/or information in a visual form to users operating the server device 1400. The keyboard is configured to provide an input means to the users. In some embodiments, operations of the user interface 1003 (e.g., the display device and the keyboard) are controlled by instructions or code stored in the user interface module within the memory 1005.

The network interface 1004 is configured to provide and control network interfaces of the server device 1400 that are used to interact with other network devices (e.g., terminal devices). The network interface 1004 can include, for example, a standard wired interface and/or a standard wireless interface (e.g., a Wi-Fi interface). In some embodiments, the network interface 1004 is used for connecting one or more terminal devices and performing data communication with the one or more terminal devices, un such embodiments, as described above with respect to FIGS. 1-11, the network interface 1004 is configured to receive, for example, virtual resource transfer instructions, resource transfer orders, messages indicating completion of transfers, instructions for actual resource transfer, confirmation messages, synchronization messages, etc., from other devices (e.g., a terminal device, an account management server, an actual resource transfer server). The network interface 1004 is also configured to transmit, for example, resource transfer requests, resource transfer links, messages indicating completion of transfers, confirmation messages, synchronization messages, etc., to other devices (e.g., a terminal device, an account management server, an actual resource transfer server), in some embodiments, operations of the network interface 1004 are controlled by instructions or code stored in the network communications module within the memory 1005.

In some embodiments, the memory 1005 can include, for example, a random-access memory (RAM) (e,g., a DRAM, a SRAM, a DDR RAM, etc.), a non-volatile memory such as one or more magnetic disk storage devices, optical disk storage devices, flash memory devices, or other non-volatile solid state storage devices. In some embodiments, the memory 1005 can include one or more storage devices (e.g., a removable memory) remotely located front other components of the server device 1400.

As shown in FIG. 14, the memory 1005 includes at least an operating system, a network communications module, a user interface module and an application program, in some embodiments, each component, program, application or module included in the memory 1005 can be a hardware-based module (e.g., a DSP, an ASIC, a FPGA), a software-based module (e.g., a module of computer code executed at a processor, a set of processor-readable instructions executed at a processor), or a combination of hardware and software modules. Instructions or code of each component, program, application or module can be stored in the memory 1005 and executed at the processor 1001. Particularly, at least a portion (e.g., a server-side portion) of the instructions or code of the methods 100, 500-600, and 900-1100 shown and described above with respect to FIGS. 1-11 are stored in the application program within the memory 1005. In some embodiments, the processor 1001 is configured to perform the instructions or code stored in the application program within the memory 1005, as shown and described above with respect to the methods 100, 500-600, and 900-1100 in FIGS. 1-11.

While particular embodiments are described above, it will be understood it is not intended to limit the invention to these particular embodiments. On the contrary, the invention includes alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as riot to unnecessarily obscure aspects of the embodiments.

Although the terms first, second, etc. may be used herein to describe various elements, these elements should not be limited by these terms. These terms are only used to distinguish one element from another. For example, first ranking criteria could be termed second ranking criteria, and, similarly, second ranking criteria could be termed first ranking criteria, without departing from the scope of the present invention. First ranking criteria and second ranking criteria are both ranking criteria, but they are not the same ranking criteria.

The terminology used in the description of the invention herein is for the purpose of describing particular embodiments only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, operations, elements, and/or components, but do not preclude the presence or addition of one or more other features, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

Although some of the various drawings illustrate a number of logical stages in a particular order, stages that are not order dependent may be reordered and other stages may be combined or broken out. While some reordering or other groupings are specifically mentioned, others will be obvious to those of ordinary skill in the art and so do not present an exhaustive list of alternatives. Moreover, it should be recognized that the stages could be implemented in hardware, firmware, software or any combination thereof.

The foregoing description, for purpose of explanation, has been described with reference to specific implementations. However, the illustrative discussions above are not intended to be exhaustive or to limit the invention to the precise forms disclosed. Many modifications and variations are possible in view of the above teachings. The implementations were chosen and described in order to best explain principles of the invention and its practical applications, to thereby enable others skilled in the art to best utilize the invention and various implementations with various modifications as are suited to the particular use contemplated. Implementations include alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the implementations.

What is claimed is:

1. A method of performing transactions, comprising:
at a server device having one or more processors and memory for storing programs to be executed by the one or more processors:
receiving, from a terminal device of a user, a virtual resource transfer instruction including a value of virtual resource to be transferred into a virtual account of the user, at least a portion of virtual resource recorded in the virtual account of the user corresponding to actual resource in a different account of the user used in a revenue-generation activity;
sending, in response to the virtual resource transfer instruction, a resource transfer request to cause an actual resource transfer server to complete an actual resource transfer in accordance with the virtual resource transfer instruction, the resource transfer request including the value of virtual resource to be transferred into the virtual account of the user;
receiving, from the actual resource transfer server, a message indicating the completion of the actual resource transfer;
increasing, in response to the message from the actual resource transfer server, an account balance of the virtual account of the user by the value of virtual resource to be transferred; and
sending, to the terminal device, a message indicating the completion of the virtual resource transfer, wherein the user of the terminal device can use the value of virtual resource transferred into the virtual account of the user to perform commercial transactions from the terminal device.

2. The method of claim 1, wherein the sending the resource transfer request to cause the actual resource transfer server to complete an actual resource transfer includes:
sending the resource transfer request to an account management server;
receiving, from the account management server, a resource transfer order in response to the resource transfer request; and
sending, in response to the resource transfer order, an instruction to the actual resource transfer server to cause the actual resource transfer server to complete the actual resource transfer in accordance with the virtual resource transfer instruction.

3. The method of claim 2, further comprising:
sending, to the account management server, a message indicating the completion of the virtual resource transfer.

4. The method of claim 2, wherein the sending the instruction to the actual resource transfer server includes:
sending, to the terminal device of the user, a link associated with the actual resource transfer such that the terminal device of the user sends an instruction to the actual resource transfer server to cause the actual resource transfer server to complete the actual resource transfer in accordance with the virtual resource transfer instruction.

5. The method of claim 1, wherein the virtual resource transfer instruction is a first virtual resource transfer instruction, the resource transfer request is a first resource transfer request, the method further comprising:
receiving, from the terminal device of the user, a second virtual resource transfer instruction including a value of virtual resource to be transferred out of the virtual account of the user;
deducting, from the account balance of the virtual account of the user and in response to the second virtual resource transfer instruction, the value of virtual resource to be transferred out of the virtual account of the user;
transferring actual resource out of a resource transfer account of the user in accordance with the second virtual resource transfer instruction;
sending, to the terminal device of the user, a message indicating the completion of the virtual resource transfer in accordance with the second virtual resource transfer instruction; and
sending, in response to the completion of the virtual resource transfer in accordance with the second virtual resource transfer instruction, a second resource transfer request such that actual resource is transferred from the account of the user into the resource transfer account of the user, the account of the user being associated with actual resource of the user used in the revenue-generation activity.

6. The method of claim 5, wherein the value of the actual resource transferred out of the resource transfer account of the user is equal to the value of the virtual resource deducted from the virtual account of the user.

7. The method of claim 5, wherein the value of the actual resource transferred from the account of the user into the resource transfer account of the user is at least the value of the virtual resource deducted from the virtual account of the user.

8. The method of claim 5, wherein the sending the second resource transfer request includes sending the second resource transfer request to an account management server such that the account management server transfers the actual resource from the account of the user into the resource transfer account of the user in accordance with the second virtual resource transfer instruction.

9. A server device, comprising:
one or more processors; and
memory storing one or more programs to be executed by the one or more processors, the one or more programs comprising instructions for:
receiving, from a terminal device of a user, a virtual resource transfer instruction including a value of virtual resource to be transferred into a virtual account of the user, at least a portion of virtual resource recorded in the virtual account of the user corresponding to actual resource in a different account of the user used in a revenue generation activity;
sending, in response to the virtual resource transfer instruction, a resource transfer request to cause an actual resource transfer server to complete an actual resource transfer in accordance with the virtual resource transfer instruction, the resource transfer request including the value of virtual resource to be transferred into the virtual account of the user;
receiving, from the actual resource transfer server, a message indicating the completion of the actual resource transfer;
increasing, in response to the message from the actual resource transfer server, an account balance of the virtual account of the user by the value of virtual resource to be transferred; and
sending, to the terminal device, a message indicating the completion of the virtual resource transfer, wherein the user of the terminal device can use the value of virtual resource transferred into the virtual account of the user to perform commercial transactions from the terminal device,

10. The server device of claim 9, wherein the sending the resource transfer request to cause the actual resource transfer server to complete an actual resource transfer includes:
sending the resource transfer request to an account management server;
receiving, from the account management server, a resource transfer order in response to the resource transfer request; and
sending, in response to the resource transfer order, an instruction to the actual resource transfer server to cause the actual resource transfer server to complete the actual resource transfer in accordance with the virtual resource transfer instruction.

11. The server device of claim 10, wherein the sending the instruction to the actual resource transfer server includes:
sending, to the terminal device of the user, a link associated with the actual resource transfer such that the terminal device of the user sends an instruction to the actual resource transfer server to cause the actual resource transfer server to complete the actual resource transfer in accordance with the virtual resource transfer instruction

12. The server device of claim 9, wherein the virtual resource transfer instruction is a first virtual resource transfer instruction, the resource transfer request is a first resource transfer request, the one or more programs further comprising instructions for:
receiving, from the terminal device of the user, a second virtual resource transfer instruction including a value of virtual resource to be transferred out of the virtual account of the user;
deducting, from the account balance of the virtual account of the user and in response to the second virtual resource transfer instruction, the value of virtual resource to be transferred out of the virtual account of the user;
transferring actual resource out of a resource transfer account of the user in accordance with the second virtual resource transfer instruction;
sending, to the terminal device of the user, a message indicating the completion of the virtual resource transfer in accordance with the second virtual resource transfer instruction; and
sending, in response to the completion of the virtual resource transfer in accordance with the second virtual resource transfer instruction, a second resource transfer request such that actual resource is transferred from the account of the user into the resource transfer account of the user, the account of the user being associated with actual resource of the user used in the revenue-generation activity.

13. The server device of claim 12, wherein the value of the actual resource transferred out of the resource transfer account of the user is equal to the value of the virtual resource deducted from the virtual account of the user.

14. The server device of claim 12, wherein the value of the actual resource transferred from the account of the user into the resource transfer account of the user is at least the value of the virtual resource deducted from the virtual account of the user.

15. The server device of claim 12, wherein the sending the second resource transfer request includes sending the second resource transfer request to an account management server such that the account management server transfers the actual resource from the account of the user into the resource transfer account of the user in accordance with the second virtual resource transfer instruction.

16. A non-transitory computer readable storage medium storing one or more programs, the one or more programs comprising instructions, which, when executed by one or more processors, cause the processors to perform operations comprising:
at a server device:
receiving, from a terminal device of a user, a virtual resource transfer instruction including a value of virtual resource to be transferred into a virtual account of the user, at least a portion of virtual resource recorded in the virtual account of the user corresponding to actual resource in a different account of the user used in a revenue-generation activity;
sending, in response to the virtual resource transfer instruction, a resource transfer request to cause an actual resource transfer server to complete an actual resource transfer in accordance with the virtual resource transfer instruction, the resource transfer request including the value of virtual resource to be transferred into the virtual account of the user;
receiving, from the actual resource transfer server, a message indicating the completion of the actual resource transfer;
increasing, in response to the message front the actual resource transfer server, an account balance of the virtual account of the user by the value of virtual resource to be transferred; and
sending, to the terminal device, a message indicating the completion of the virtual resource transfer, wherein the user of the terminal device can use the value of virtual resource transferred into the virtual account of the user to perform commercial transactions from the terminal device.

17. The non-transitory computer readable storage medium of claim 16, wherein the sending the resource transfer request to cause the actual resource transfer server to complete an actual resource transfer includes:
sending the resource transfer request to an account management server;
receiving, from the account management server, a resource transfer order in response to the resource transfer request; and
sending, in response to the resource transfer order, an instruction to the actual resource transfer server to cause the actual resource transfer server to complete the actual resource transfer in accordance with the virtual resource transfer instruction.

18. The non-transitory computer readable storage medium of claim 17, wherein the sending the instruction to the actual resource transfer server includes:
sending, to the terminal device of the user, a link associated with the actual resource transfer such that the terminal device of the user sends an instruction to the actual resource transfer server to cause the actual resource transfer server to complete the actual resource transfer in accordance with the virtual resource transfer instruction.

19. The non-transitory computer readable storage medium of claim 16, wherein the virtual resource transfer instruction is a first virtual resource transfer instruction, the resource transfer request is a first resource transfer request, the one or more programs further comprising instructions for:
receiving, from the terminal device of the user, a second virtual resource transfer instruction including a value of virtual resource to be transferred out of the virtual account of the user;
deducting, from the account balance of the virtual account of the user and in response to the second virtual resource transfer instruction, the value of virtual resource to be transferred out of the virtual account of the user;
transferring actual resource out of a resource transfer account of the user in accordance with the second virtual resource transfer instruction;
sending, to the terminal device of the user, a message indicating the completion of the virtual resource transfer in accordance with the second virtual resource transfer instruction; and
sending, in response to the completion of the virtual resource transfer in accordance with the second virtual resource transfer instruction, a second resource transfer request such that actual resource is transferred from the account of the user into the resource transfer account of the user, the account of the user being associated with actual resource of the user used in the revenue-generation activity.

20. The non-transitory computer readable storage medium of claim 16, wherein the sending the second resource transfer request includes sending the second resource transfer request to an account management server such that the account management server transfers the actual resource from the account of the user into the resource transfer account of the user in accordance with the second virtual resource transfer instruction.
